(19) United States
(12) Patent Application Publication
(10) Pub. No.: US 2009/0044105 A1
(43) Pub. Date: Feb. 12, 2009

(54) INFORMATION SELECTING SYSTEM, METHOD AND PROGRAM

(75) Inventors: YOSHIKO MATSUKAWA, TOKYO (JP); SUSUMU AKAMINE, TOKYO (JP); SHINICHI DOI, TOKYO (JP); SATOSHI NAKAZAWA, TOKYO (JP); TAKAO KAWAI, TOKYO (JP); TOSHIO TAKEDA, TOKYO (JP)

Correspondence Address: YOUNG & THOMPSON, 209 Madison Street, Suite 500, ALEXANDRIA, VA, 22314, US

(73) Assignee: NEC CORPORATION, TOKYO (JP)

(21) Appl. No.: 12/186,785

(22) Filed: Aug. 6, 2008

(30) Foreign Application Priority Data
Aug. 8, 2007 (JP) 2007-206395

(51) Int. Cl. G06F 17/20

(52) U.S. Cl. 715/256

(57) ABSTRACT

The need for a user to select by themselves a word or word string about which the user wants to obtain information from among words or word strings presented by a system can be eliminated. An information selecting system includes word string extracting unit for extracting words or word strings from input data, a statistical data obtaining unit for obtaining statistical data concerning the words or word strings extracted by the word string extracting unit from a group of electronic documents related to the user, and selecting unit for selecting a word or word string inferred to be less understood by the user on the basis of statistical data obtained by the statistical data obtaining unit.

### BACKGROUND OF THE INVENTION

1. Field of the Invention

The present invention relates to an information selecting system, method, and program for selecting words or words strings that are less understood by users.

2. Description of the Related Art

When listeners encounter a word unknown, unfamiliar, or incomprehensible to them in a conference or conversation, they generally have no other choice but to inquire about the meaning of the word in the conference or conversation or look up the word later by themselves. However, questions from listeners in the conference or conversation can interrupt the flow of the conference or conversation. Furthermore, listeners often cannot correctly catch words in a conference or conversation or do not know the correct spellings of the words. Consequently, listeners often cannot look up the words later in a dictionary by themselves.

An example of systems capable of aiding users who are listeners in looking up unknown, unfamiliar, or incomprehensible words is described in Japanese Patent Laid-Open No. 2002-259373. In the example of the information presentation system in the document, a user selects a word about which the user wants to obtain dictionary information from among words presented by the system. Then dictionary information about the word selected by the user is outputted as speech.

The information presentation system described in Japanese Patent Laid-Open No. 2002-259373 includes means for outputting continuous speech, means for inputting a timing specification by an operator (word button), speech recognition means, means for identifying a word in continuous speech on the basis of the result of the speech recognition and the timing specification, means for generating dictionary information based on the identified word, and means for outputting the dictionary information.

The information presentation system having the configuration described above operates as follows. When a user presses the word button during playback of speech data, the information presentation system pauses the playback of the speech data. Then, the information presentation system recognizes speech data in a predetermined period of time immediately before the button was depressed. The information presentation system segments the speech data into one or more words and presents the word or words to the user. The user presses the word button again while the word about which the user wants to obtain dictionary information is being presented. Then, the information presentation system identifies the word presented at the time the word button was pressed, obtains dictionary information about the word, and presents the dictionary information to the user.

The information presentation system of the related art disclosed in the Japanese Patent Laid-Open No. 2002-259373 is incapable of inferring the word or word string about which the user wants to obtain information. Therefore, the information presentation system has a problem that the user needs to select by themselves the word or word string about which the user wants to obtain information from among words or word strings presented by the system.

For example, when a user wants to use a dictionary search service and presses a dictionary search button, the word selected at the time the button was pressed may not match the word the user wants to look up in the dictionary. Consequently, the user needs to perform the operation again to select the word to look up in the dictionary, that is, the word about which the user wants to obtain additional information.

Suppose for example a user wants to obtain dictionary information about the word “puppies” while speech data “I like puppies” is being played back. When the user presses the word button during the playback of the speech data “I like puppies”, the information presentation system described in Japanese Patent Laid-Open No. 2002-259373 recognizes the speech “I like puppies” and segments the speech into three words: “I”, “like”, and “puppies”. The information presentation system then presents the words to the user one after another. Because the user wants to obtain dictionary information about the word “puppies”, the user presses the word button again while the word “puppies” is being presented. The information presentation system identifies that the word about which the user wants to obtain dictionary information is “puppies”. The information presentation system obtains dictionary information concerning “puppies” and presents the dictionary information to the user. In this way, the user has to perform the select operation in order to obtain the dictionary information about the word “puppies”, which is troublesome.

Therefore, an object of the present invention is to provide an information selecting system, method and program capable of eliminating the need for a user to select by themselves a word or word string about which the user wants to obtain information from among words or word strings presented by a system.

### SUMMARY

Exemplary embodiments of the present invention overcome the above disadvantages and other disadvantages not described above. Also, the present invention is not required to overcome the disadvantages described above, and an exemplary embodiment of the present invention may not overcome any of the problems described above.

An information selecting system according to the present invention includes word string extracting unit for extracting word or word strings from input data, statistical data obtaining unit for obtaining statistical data concerning words or word strings extracted by the word string extracting unit from a group of electronic documents relating to a user, and selecting unit for selecting a word or word string inferred to be less understood by a user on the basis of statistical data obtained by the statistical data obtaining unit.

An information selecting method according to the present invention includes the steps of extracting word or word strings from input data, obtaining statistical data concerning words or word strings extracted by the word string extracting unit from a group of electronic documents related to a user, and selecting a word or word string inferred to be less understood by a user on the basis of statistical data obtained by the statistical data obtaining unit.

A program for selecting information according to the present invention causes a computer to perform the steps of extracting word or word strings from input data, obtaining statistical data concerning words or word strings extracted by the word string extracting unit from a group of electronic documents related to a user, and selecting a word or word string inferred to be less understood by a user on the basis of statistical data obtained by the statistical data obtaining unit.

The present invention obtains statistical data concerning each of words or word strings extracted from input data and selects a word or word string inferred to be less understood by a user on the basis of statistical data obtained by the statistical data obtaining unit. Accordingly, the present invention eliminates the need for a user to select by themselves a word or word string about which the user wants to obtain information from among words or word strings presented by a system.

### BRIEF DESCRIPTION OF THE DRAWINGS

This above-mentioned and other objects, features and advantages of this invention is come more apparent by reference to the following detailed description of the invention taken in conjunction with the accompanying drawings, wherein:

FIG. 1 is a block diagram showing an exemplary configuration of an information selecting system according to the present invention;

FIG. 2 is a flowchart showing an exemplary process performed by the information selecting system for selecting word or word strings less understood by a user;

FIG. 3 is a block diagram showing an exemplary configuration of an information selecting system in a second exemplary embodiment;

FIG. 4 is a flowchart showing a process performed by the information selecting system for selecting a word or word string less understood by a user in the second exemplary embodiment;

FIG. 5 is a diagram illustrating an example of a structure of a document database that includes different databases for different groups and different users;

FIG. 6 is a diagram illustrating an example of information stored in one of the user databases included in the document database;

FIG. 7 is a flowchart showing an exemplary process for selecting words or word strings by obtaining the frequencies of occurrence in user documents;

FIG. 8 is a flowchart showing an exemplary process for selecting a word or word string by obtaining the frequencies of occurrence in user documents and related documents;

FIG. 9 is a flowchart showing an exemplary process for selecting a word or word string by identifying user document update dates and times;

FIG. 10 is a flowchart showing an exemplary process for selecting a word or word string by obtaining the frequencies of occurrence in user documents, the frequencies of occurrence in related documents, user document update dates and times, and related document update dates and times; and

FIG. 11 is a block diagram showing an example of a minimum configuration of an information selecting system.

### DETAILED DESCRIPTION OF THE PREFERRED EMBODIMENTS

### First Exemplary Embodiment

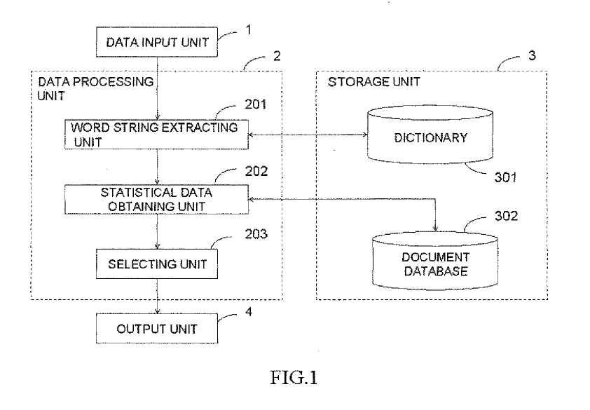

A first exemplary embodiment of the present invention will be described below with reference to the accompanying drawings. FIG. 1 is a block diagram showing an exemplary configuration of an information selecting system according to the present invention. The information selecting system according to the first exemplary embodiment selects a word or word string about which a user wants to obtain additional information and presents the word or word string to the user.

Additional information a user wants to obtain may the meaning or translation, common usage, or etymology of the word or word string, for example. Additional information a user wants to obtain may be various kinds of information retrieved by search through a communication network such as the Internet. The information retrieved may be a content containing the word or word string or a portion of text around the word or word string in content.

As shown in FIG. 1, the information selecting system includes data input unit 1, output unit 4, data processing unit 2, and storage unit 3 storing information. These units operate as follows.

The data input unit 1 receives data inputted in accordance with an operation by a user. In particular, the data input unit 1 is implemented by an input device such as a microphone or keyboard. The output unit 4 displays information or outputs audio in accordance with an instruction from the data processing unit 2. In particular, the output unit 4 is implemented by a display device such as a display monitor or an audio output device such as speakers.

The data processing unit 2 inputs input data from the data input unit 1 in accordance with an input operation performed by a user. In particular, the data processing unit 2 is implemented by a program-controlled information processor such as a personal computer. As shown in FIG. 1, the data processing unit 2 includes word string extracting unit 201 statistical data obtaining unit 202, and selecting unit 203.

For example, text data such as electronic documents may be input as input data from the data input unit 1 into the data processing unit 2. If the data input unit 1 is an audio input device such as a microphone, the data processing unit 2 may recognize input speech data and convert it into text data, which is used as input data.

In particular the word string extracting unit 201 is implemented by a CPU of the information processor operating in accordance with a program. The word string extracting unit 201 refers to a dictionary 301 stored in the storage unit 3 and extracts words or word strings from input data.

The word string extracting unit 201 may extract a word, compound word, segment, phrase, sentence, paragraph, section, clause, or chapter as a unit of word or word string extraction.

In particular, the statistical data obtaining unit 202 is implemented by a CPU of an information processor operating in accordance with a program. The statistical data obtaining unit 202 refers to a document database 302 stored in the storage unit 3 and obtains statistical data concerning words or word strings extracted from a group of electronic documents related to the user by the word string extracting unit 201.

An example of statistical data obtained by the statistical data obtaining unit 202 is data indicating frequency and time statistics concerning words or word strings extracted by the word string extracting unit 201. For example, the statistical data obtaining unit 202 obtains the frequencies of occurrence of words or word strings in electronic documents created by a user (hereinafter referred to as the frequencies of occurrence in user documents) as statistical data. The statistical data obtaining unit 202 also obtains the frequencies of occurrence of words or word strings in electronic documents created by a person related to the user (hereinafter referred to as the frequencies of occurrence in related documents) as statistical data. Furthermore, the statistical data obtaining unit 202 identifies the update dates and times on which the user updated electronic documents (hereinafter referred to as the user document update dates and times) as statistical data. The statistical data obtaining unit 202 also identifies the update dates and times on which a person related to the user updated electronic documents (hereinafter referred to as related document update dates and times) as statistical data.

In particular, the selecting unit 203 is implemented by the CPU of the information processor operating in accordance with a program. The selecting unit 203 includes the function of selecting words or word strings that are inferred to be less understood by the user on the basis of statistical data obtained by the statistical data obtaining unit 202.

The storage unit 3 is implemented by a storage device such as a magnetic disk device or an optical disk device, in particular. As shown in FIG. 1, the storage unit 3 includes a dictionary 301 and a document database 302.

The dictionary 301 contains information required for extracting words or word strings from input data. For example, the storage unit 3 stores dictionary data containing words of Japanese and other languages as the dictionary 301.

The document database 302 contains a group of electronic documents related to the user. For example, the document database 302 stores electronic documents created, edited, or referred to by the user in the past. The document database 302 may contain a list of the frequencies of occurrence of words in the electronic documents.

The document database 302 may contain at least one category of electronic document among electronic documents created by the user, electronic documents created by a member of a team (group) to which the user belongs, and electronic documents in the user's area of specialization, for example, as electronic documents related to the user. The document database 302 may also contains listed information about the frequency of occurrence of words or word strings in each electronic document related to the user (for example a list the frequencies of occurrence).

The user does not necessarily need to input information to store by themselves. That is, the information selecting system may automatically obtain information to store. Furthermore, the information selecting system may update information stored in the document database 302 every time a change is made.

For example, the data processing unit 2 of the information selecting system may include document updating unit for updating information stored in the document database 302. In that case, the document updating unit accesses a shard file server provided in a company at predetermined time intervals. In response to a request from the document updating unit, the shared file server retrieves an updated electronic document and sends the electronic document to the document updating unit through a communication network. Then, the document updating unit updates information stored in the document database 302 on the basis of the electronic document it received.

A storage device (not shown) of the data processing unit 2 of the present exemplary embodiment stores various programs for selecting words or word strings that may be less understood by users. For example, the storage device of the data processing unit 2 stores an information selecting program for causing a computer to perform a word string extracting process for extracting words or word strings from input data, a statistical data obtaining process for obtaining statistical data concerning extracted words or word strings from a group of electronic documents related to the user, and a selecting process for selecting a word or word string that is inferred to be less understood by the user on the basis of the obtained statistical data.

The overall operation of the first exemplary embodiment is illustrated in FIG. 2. FIG. 2 is a flowchart showing an exemplary process performed by the information selecting system for selecting a word or word string that is likely to be less understood by a user. First, the data processing unit 2 inputs input data from the data input unit 1 in response to an input operation performed by the user (S101). Then, the word string extracting unit 201 refers to the dictionary 301 stored in the storage unit 3 and extracts words or word strings from the input data (S102).

Then, the statistical data obtaining unit 202 refers to the document database 302 stored in the storage unit 3 and obtains statistical data concerning the words or word strings extracted by the word string extracting unit 201 (S103). The selecting unit 203 selects a word or word string that is inferred to be less understood by the user on the basis of the statistical data obtained by the statistical data obtaining unit 202 (S104).

Then, the selecting unit 203 causes the output unit 4 to present the selected word or word string (S105). In this case, the selecting unit 203 outputs the selected word or word string to the output unit 4. For example, if the output unit 4 is a display device such as a display monitor, the output unit 4 displays the selected word or word string on the display device. If the output unit 4 is an audio output device such as a speaker, the output unit 4 outputs the selected word or word string through the audio output device as speech.

In this way, the statistical data obtaining unit 202 in the information selecting system of the present exemplary embodiment refers to the document database 302 stored in the storage unit 3 and obtains statistical data concerning the words or word strings extracted by the word string extracting unit 201. The selecting unit 203 selects a word or word string that is inferred to be less understood by the user on the basis of the statistical data obtained by the statistical data obtaining unit 202. Thus, the information selecting system can infer and present a word or word string about which the user wants to obtain additional information. Therefore, the present exemplary embodiment has the effect of eliminating the need for the user to perform an operation for selecting by themselves the word or word string about which the user wants to obtain additional information from among words or word strings presented by a system.

Furthermore, the information selecting system according to the present exemplary embodiment is capable of presenting a word spoken by a speaker even if the user did not catch the word aright. The word thus presented can be used as a search keyword. Accordingly, the information selecting system of the present exemplary embodiment can avoid a situation in which a user cannot search for a word because the user cannot properly specify a keyword. Thus the present exemplary embodiment has the effect of allowing a user to readily look up a word or word string by themselves after a conference, for example.

Furthermore, the information selecting system according to the present exemplary embodiment allows a user to readily look up a word about which the user wants to obtain additional information later by themselves. This eliminates the need for the user to ask questions about words in a conference and therefore does not interrupt the flow of the conference or conversation.

The information selecting system according to the present exemplary embodiment is capable of presenting on the spot a word that is likely to have been missed by the user during a conference or conversation. This can avoid the user from being distracted from the rest of the story to the missed word and decreasing the level of user's understanding of the whole story decreases. Thus, the information selecting system has the effect of alleviating communication problems in the conference or conversation.

An approach is described in Japanese Patent Laid-Open No. 2004-240859 to learning the levels of familiarity of a user with words on the basis of words used in text created by the user and text that the user read and understood. The system described in the Japanese Patent Laid-Open No. 2004-240859 can infer a word about which the user would want to obtain information to some extent on the basis of the familiarity levels determined by using the related-art technique.

However, the related-art system determines that the user is familiar with a word if the word appears at least once in text the user created or read and understood. Therefore, the related-art system cannot always properly infer a word about which the user wants to obtain information. In general, users are not necessarily familiar with a word that appears once in text they created or read and understood. Therefore, the related-art system may fail to properly infer a word about which the user wants to obtain information.

In contrast, the information selecting system according to the present exemplary embodiment selects a word or word string on the basis of user's level of understanding inferred on the basis of statistical data. With this configuration, it is possible to properly infer whether the user is familiar with a word or word string. Thus, the information selecting system according to the present invention is capable of properly inferring and presenting a word about which the user wants to obtain information.

The information selecting system according to the exemplary embodiment described above extracts words or word strings from input data whenever data is input. However, the information selecting system may extract words or word strings from input data in response to a find command input by a user after data is input. In this case, the information selecting system may include command input unit implemented by an input device such as a keyboard, microphone, or camera. The word string extracting unit 201 of the data processing unit 2 may perform a process for extracting words or word strings in response to a command input from the command input unit at step S102 after data input at step S101.

With the configuration described above, words or word strings are extracted from input data in response to a find command input by a user. Thus, the information selecting system perform the process for extracting words or word strings only when a find command is issued by a user and therefore the load of the process for extracting the word or word string can be reduced.

The exemplary embodiment described above presents to the user a word or word string selected as a word or word string likely to be less understood by the user, that is, about which the user may want to obtain additional information. However, a word or word string selected as a word or word string about which the user may want to obtain additional information may be presented in response to a command to obtain additional information issued by the user. In this case, the information selecting system performs the process from step S101 through S105 for selecting a word or word string every time data is input. The information selecting system causes the output unit 4 to display the selected word or word string in response to a command to obtain additional information issued by the user through the command input unit.

With the configuration, the information selecting system selects a word or word string about which the user may want to obtain additional information and, only when the user has issued an instruction to obtain additional information, presents the word or word string. This configuration has the effect that the time between the issuance of a request from a user for additional information about a word or word string and the presentation of the additional information can be reduced as compared with the configuration in which the process for selecting the word or word string is started in response to the input of a find command from the user.

The information selecting system according to the present exemplary embodiment can be applied to a search system that searches the Web or a dictionary for a word or word string, for example. The information selecting system according to the exemplary embodiment is also applicable to a conference support system for video or Web conference. The information selecting system according to the exemplary embodiment is also applicable to a reading support system which facilitates reading various kinds of text or searches for translations of words to provide translated text. The information selecting system according to the exemplary embodiment is also applicable to a learning support system which searches for various kinds of learning information such as language learning information.

For example, when the information selecting system is applied to a conference support system, the information selecting system includes speech input unit such as a microphone for inputting speech data during a conference. The word string extracting unit 201 extracts words or words strings from speech data input through the speech input unit. In this case, the word string extracting unit 201 extracts words or word strings from text data resulting from speech recognition of speech data input. The information selecting system of the example further includes information search unit (not shown) for searching for information on the basis of the words or word strings selected by the selecting unit 203 and information presentation unit (not shown) for presenting information retrieved by the information search unit.

### Second Exemplary Embodiment

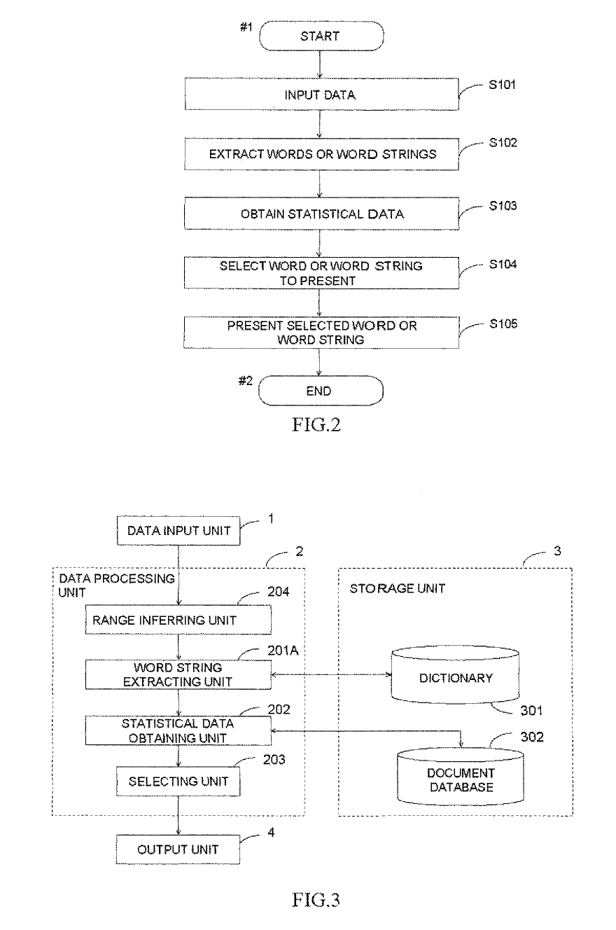

A second exemplary embodiment of the present invention will be described with reference to drawings. FIG. 3 is a block diagram showing an exemplary configuration of an information selecting system according to the second exemplary embodiment. As shown in FIG. 3, the information selecting system of the second exemplary embodiment differs from the information selecting system of the first exemplary embodiment in that the data processing unit 2 includes range inferring unit 204 in addition to the components shown in FIG. 1. Furthermore, the word string extracting unit 201A in the second exemplary embodiment differs in function from the word string extracting unit 201 shown in the first exemplary embodiment.

In particular, the range inferring unit 204 is implemented by a CPU of an information processor operating in accordance with a program. The range inferring unit 204 infers a range in input data in which words or word strings are to be extracted.

The word string extracting unit 201A refers to a dictionary 301 stored in the storage unit 3 and extracts words or word strings from a range in input data inferred by the range inferring unit 204. The word string extracting unit 201A may extract words or word strings in a given range in input data, such as a predetermined period of time, a predetermined number of characters, or a segment between punctuation marks.

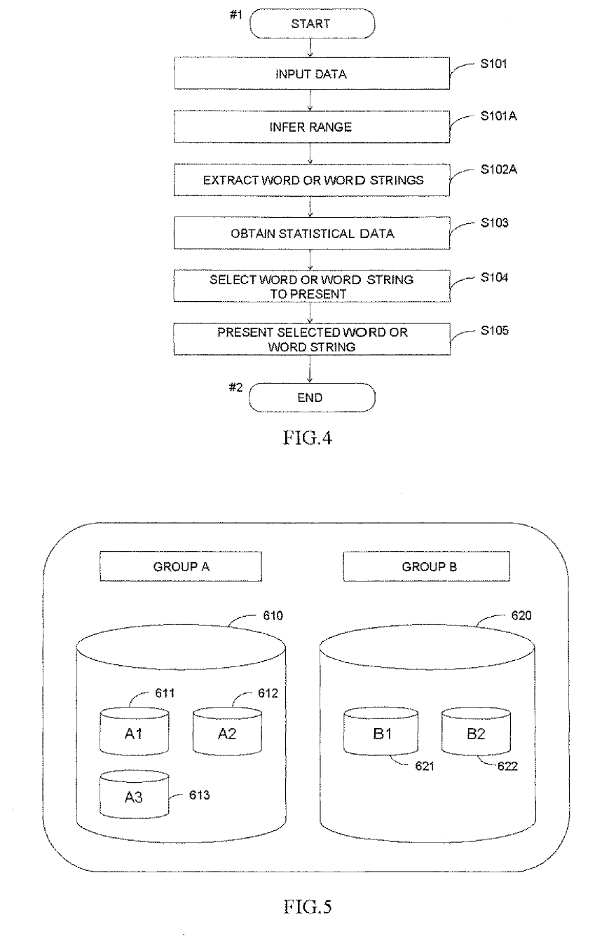

Overall operation of the information selecting system according to the second exemplary embodiment will be described below. FIG. 4 is a flowchart showing an exemplary process performed by the information selecting system for selecting a word or word string that is likely to be less understood by a user according to the second exemplary embodiment. The information selecting system of the first exemplary embodiment extracts words or word strings when data is input in the system, and sequentially infers a user's level of understanding of the words or word strings. The information selecting system according to the second exemplary embodiment first infers a range in which words or word strings are to be extracted when data is input in the system. After inferring the range, the information selecting system according to the second exemplary embodiment infers the user's levels of understanding of words or word strings extracted from the range.

First, the data processing unit 2 inputs data from the data input unit 1 in accordance with an input operation performed by a user in a manner similar to that in the first exemplary embodiment (S101). Then, the range inferring unit 204 infers a range in the input data from which words or word strings are to be extracted (S101A). Then the word string extracting unit 201 refers to the dictionary 301 stored in the storage unit 3 and extracts words or word strings from the range in the input data inferred by the range inferring unit 204 (102A).

The operations of the statistical data obtaining unit 202, selecting unit 203, and output unit 4 shown at the subsequent steps S103 through S105 in the second exemplary embodiment are the same as the operations of the equivalent unit in the first exemplary embodiment.

As has been described, the information selecting system according to the second exemplary embodiment automatically infers a word or word string less understood by a user, like the system of the first exemplary embodiment. Therefore, the second exemplary embodiment eliminates the need for the user to perform an operation to select the word or word string about which the user wants to obtain additional information from among words or words strings presented by a system.

Furthermore, when data is input, the information selecting system according to the second exemplary embodiment infers a range in the input data from which words or word stings are to be extracted and infer the user's levels of understanding of the words or word strings extracted from the range inferred. Therefore, the load of the process for inferring the user's levels of understanding can be reduced as compared with the load of the process in the first exemplary embodiment in which user's levels of understanding of words or word strings are sequentially extracted and are inferred one by one.

### FIRST EXAMPLE

A first example of the present invention will be described with reference to drawings. The first example is more specific than the first exemplary embodiment. The information selecting system in the first example includes a microphone as data input unit 1 and a personal computer as data processing unit 2. The information selecting system in the first example also includes a magnetic disk device as storage unit 3 and a display device as output unit 4.

The personal computer includes a central processing unit that functions as word string extracting unit 201, statistical data obtaining unit 202, and selecting unit 203. The magnetic disk device contains a dictionary 301 and a document database 302.

When speech data is input through the data input unit 1, the word string extracting unit 201 starts speech recognition and refers to the dictionary 301 to convert the speech data to text data. The word string extracting unit 201 extracts words or word strings from the text data resulting from the speech recognition. The speech recognition technique is a heretofore known technique and therefore the description of which will be omitted.

The word string extracting unit 201 may be configured to extract a word, compound word, segment, phrase, or sentence or the like as a unit of word or word string extraction. The unit of word or word string extraction may be a word (self-sufficient word) that is neither a postpositional particle nor an auxiliary verb so that the efficiency of processing by the statistical data obtaining unit 202 and the selecting unit 203 may be increased. In the example described below, the unit of extraction is a self-sufficient word. Examples of self-sufficient words include nouns, proper nouns, deverbal nouns (such as “movement” and “assignor”), and verbs.

The word string extracting unit 201 sequentially sends (outputs) extracted words or word strings to the statistical data obtaining unit 202. The statistical data obtaining unit 202 refers to the document database 302 and computes statistical data concerning words or word strings.

The document database 302 contains a group of electronic documents related to the user. The group of electronic documents related to the user may include electronic documents created by the user, electronic documents created by a member of a team to which user belongs and electronic documents in the user's area of specialization, for example. The document database 302 may also contain a list of the frequencies of occurrence of words or word strings in each electronic document.

The information selecting system may automatically obtain information to store the document database 302, instead of the user having to input information. Furthermore, the information selecting system may automatically update the information stored in the document database 302 each time a change is made.

The document database 302 may include separate databases for storing electronic documents related to different groups or users. FIG. 5 shows an example of a structure of the document database 302 including separate databases for different groups and users. As shown in FIG. 5, the document database 302 includes databases 610 and 620 for groups A and B, respectively. The document database 302 also includes databases 611, 612, and 613 for users A1, A2, and A3, respectively, in group A. The document database 302 also includes data databases 621 and 622 for users B1 and B2, respectively, in group B.

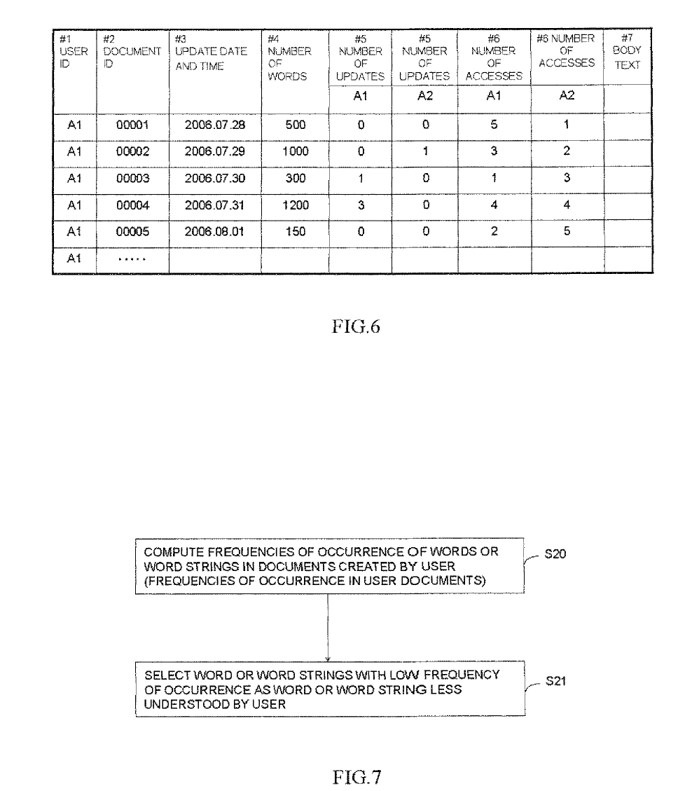

FIG. 6 shows an example of information stored in a user database in the document database 302. Information stored in the database for user A1 is shown in FIG. 6 by way of example. As shown in FIG. 6, the user database stores a user ID, document IDs, update dates and times, the number of words, the numbers of updates A1 and A2, the numbers of accesses A1 and A2, and body text in association.

The user ID in FIG. 6 identifies the user. The document IDs identify electronic documents stored. The update dates and times are dates and times on which the electronic documents were last updated. The body text is the body text of the electronic documents. The document database 302 may store electronic document creation dates and times and access dates and times in addition to the update dates and times.

The number of words represents the number of words contained in each electronic document. For example, whenever a new electronic document is created, the document updating unit provided in the data processing unit 2 may perform morphological analysis of the electronic document to obtain the number of the words contained in the electronic document and stores the number in the document database 302.

The number of updates represents the number of updates of each electronic document. For example, whenever the electronic document is updated by a user, the document updating unit increments (adds 1 to) the number of updates by that user stored in the document database 302.

The number of accesses is the number of times each electronic document is accessed (referenced, for example). For example, each time the electronic document is accessed by a user, the document updating unit increments (adds 1 to) the number of accesses by that user stored in the document database 302.

The statistical data obtaining unit 202 computes the frequencies of occurrence of words or word strings in electronic documents created by a user (the frequencies of occurrence in the user documents) as statistical data as described below. In the following description, the user is denoted by Y (user Y).

FIG. 7 is a flowchart showing an exemplary process for obtaining the frequencies of occurrence in the user documents to select a word or word string. In general, words or word strings that appear less frequently in an electronic document created by a user are presumably less understood by the user. The process for selecting a word or word string in the example shown in FIG. 7 is based on the assumption.

The operation at step S20 corresponds to step S103 shown in the first exemplary embodiment and the operation at step S21 corresponds to step S104 shown in the first exemplary embodiment.

First, the statistical data obtaining unit 202 retrieves electronic documents created by user Y from the document database 302 and obtains the frequencies of occurrence of words or word strings in the extracted electronic documents (the frequencies of occurrence in the user documents) as statistical data (S20). The selecting unit 203 selects a word or word string with a low frequency of occurrence in the user documents obtained by the statistical data obtaining unit 202 as a word or word string less understood by the user (S21).

For example, the statistical data obtaining unit 202 selects and extracts electronic documents created by user Y from the document database 302 at step S202 and performs character string matching between each of the extracted electronic documents and words or word strings extracted by the word string extracting unit 201. Then, the statistical data obtaining unit 202 computes the average number of times a word or word string appears in the electronic documents created by user Y from the total number of times the word or word string appears in all the electronic documents created by user Y and the sum of the numbers of words in all the electronic documents created by user Y ((sum of word counts)/total number of occurrences) as the frequency of occurrence in the user documents. The selecting unit 203 compares the frequency of occurrence in the user documents obtained by the statistical data obtaining unit 202 with a predetermined threshold (for example 0.05 (one occurrence in 20 words)). The selecting unit 203 infers all words or word strings with frequencies of occurrence in the user documents that are lower than the predetermined threshold to be less understood by the user.

For example, if the average of the numbers of times the word “spring” appears in the electronic documents created by user Y is “0.1” (one occurrence in ten words), the statistical data obtaining unit 202 determines that the frequency of occurrence in the user documents is 0.1. Similarly, the average of the numbers of times the word “summer” appears in the electronic documents created by user Y is “0.01” (one occurrence in 100 words), the statistical data obtaining unit 202 determines that frequency of occurrence in the user documents is 0.01. Then, the selecting unit 203 compares each of the frequencies of occurrence in the user documents obtained by the statistical data obtaining unit 202, “0.01” and “0.01”, with the predetermined threshold, “0.05”. Because the frequency of occurrence of the word “summer” is smaller than the threshold, the selecting unit 203 selects the word “summer” as the word or word string about which the user will want to obtain additional information.

If list of frequencies of occurrence has been stored in the document database 302 beforehand, the statistical data obtaining unit 202 matches each word or word string against the list to obtain the frequency of occurrence in the user documents.

Not all the words or word strings with frequencies of occurrence lower than the predetermined threshold are the words or word strings about which the user wants to obtain additional information. The information selecting system may be configured to select only one word with the lowest frequency of occurrence in the user documents, for example.

Through the computation described above, the selecting unit 203 selects a word or word string that may be less understood by the user as the word or word string about which the user wants to obtain additional information and sends (outputs) the word or word string to the output unit 4. The output unit 4 presents (displays) the selected word or word string on the display device of user Y in accordance with an instruction from the selecting unit 203.

The process described above will be further described with respect to a specific example. Suppose speaker Z is giving a lecture on investment in stock market and listener Y is listening to the lecture. When speaker Z says, “briks er kapchering thi atensh'n ov investerz theez dayz (BRICs are capturing the attention of investors in these days)”, the speech data is input in the information selecting system, which then performs speech recognition. The information selecting system provides the result of the speech recognition as “BRICs are capturing the attention of investors in these days”.

Then, the word string extracting unit 201 of the information selecting system refers to the dictionary 301 and extracts the self-sufficient words “BRICs”, “capturing”, “attention”, “investors”, and “days”, from the data obtained as the result of the speech recognition and sends (outputs) the words to the statistical data obtaining unit 202.

The statistical data obtaining unit 202 computes the frequencies of occurrence of the extracted words or word strings in electronic documents created by listener Y (frequencies of occurrence in the user documents). Then, the statistical data obtaining unit 202 obtains a frequency of occurrence of 0.01 for “BRICs”, 0.7 for “attention”, 0.4 for “investors”, and 0.8 for the word “days”.

The selecting unit 203 compares the frequencies of occurrence in the user documents obtained by the statistical data obtaining unit 202 with a predetermined threshold, “0.05” and infers the word “BRICs” whose frequency of occurrence is less than the threshold to be a word less understood by the user. The selecting unit 203 also determines that the word “BRICs” is a word or word string about which listener Y will want to obtain additional information and causes the display device of listener Y to present (display) the word “BRICs”.

Data input in the information selecting system through the data input unit 1 is not limited to speech data. For example, streaming data such as text of a scrolling ticker or captions or still data such as text input through a keyboard or an OCR may be input in the information selecting system through the data input unit 1.

The method for presenting the selected word or word string about which the user is likely to want to obtain additional information is not limited to displaying it on the display device of listener Y. The information selecting system may allow the user to specify a desired method for displaying the selected word or word string. For example, the information selecting system may also display the selected word or word string on the speaker Z's display device at the same time. With this configuration, the information selecting system can notify speaker Z of the presence of the listener who does not understood the word and, thereby prompting speaker Z to elaborate on the word.

Furthermore, the information selecting system may save the selected word or word string in a file specified beforehand by listener Y. This configuration allows listener Y to use the file as a note used in looking up the word or word string later by themselves.

The word or word string selected as a word or word string about which the user is likely to want to obtain additional information may he presented as speech. The information selecting system may present the selected word or word string both as a visual display on the display device and as speech output.

The selected word or word string may be used as a keyword for Web or dictionary search.

As has been described, the information selecting system according to the present example obtains the frequencies of occurrence in user documents as statistical data and infers a word or word string with a low frequency of occurrence in the user documents to be less understood by the user. Thus, a word or word string less understood by the user can be readily inferred and selected as a word or word string to present to the user.

While the present example has been described with respect to a case where the frequencies of occurrence in user documents are obtained as frequency information related to the user, frequency information related to the user obtained by the statistical data obtaining unit 202 is not limited to the information given in the present example.

For example, a word or word string that appears in an electronic document that has been infrequently updated or accessed by the user may be inferred to be less understood by the user. In this case, for example the statistical data obtaining unit 202 may perform character matching or character string matching with all electronic documents in the database to identify an electronic document in which words or word strings extracted by the word string extracting unit 201 appear. Then the statistical data obtaining unit 202 obtains the number of updates or accesses to the identified electronic document made by the user. The selecting unit 203 compares the number of updates or accesses obtained by the statistical data obtaining unit 202 with a predetermined threshold (for example 20 times) and infers all words or word strings that have been updated or accessed less than the predetermined threshold to be less understood by the user.

### SECOND EXAMPLE

A second example of the present invention will be described with reference to drawings. The second example is more specific than the first example. While the information selecting system in the first example obtains the frequencies of occurrence in user documents as statistical data, the information selecting system in the second example obtains the frequencies of occurrence of words or word strings in electronic documents created by a person related to a user (frequencies of occurrence in related documents) in addition to the frequencies of occurrence in user documents created by the user.

FIG. 8 is a flowchart showing an exemplary process for obtaining the frequencies of occurrence in user documents and the frequencies of occurrence in related documents to select a word or word string. In general, words or word strings that appear less frequently in electronic documents created by a user than in electronic documents created by a member of the group to which the user belongs can be inferred to be less understood by the user. In the process in the example shown in FIG. 8, words or word strings are selected on the basis of this assumption.

Operations at step S30 and S31 in FIG. 8 correspond to step S103 shown in the first exemplary embodiment and operation at step S32 corresponds to step S104 shown in the first exemplary embodiment.

First, statistical data obtaining unit 202 retrieves electronic documents created by user Y from a document database 302 and obtains the frequencies of occurrence of words or word strings in the retrieved electronic documents (frequencies of occurrence in user documents) as statistical data (S30). The statistical data obtaining unit 202 also retrieves electronic documents created by a member of the group to which user Y belongs (for example the supervisor) from the document database 302 and obtains the frequencies of occurrence of words or word strings in the retrieved electronic documents (frequencies of occurrence in related documents) as statistical data (S31). The selecting unit 203 infers words or words strings the frequencies of occurrence of which in the user documents obtained by the statistical data obtaining unit 202 are lower than the frequencies of occurrences in the related documents to be less understood by the user and selects those words or word strings as words or word strings about which the user will want to obtain additional information (S32).

The method shown in the present example selects words or word strings that appear less frequently in electronic documents created by user Y than in electronic documents created by the supervisor of user Y as words or word strings about which the user will want to obtain additional information. To this end, the statistical data obtaining unit 202 selects and retrieves electronic documents created by user Y and electronic documents created by the supervisor of user Y from a document database 302. The statistical data obtaining unit 202 performs character string matching between the words or word strings extracted by the word string extracting unit 201 for both sets of electronic documents. The statistical data obtaining unit 202 obtains the average of the numbers of times each of the extracted words or word strings appears in each of the sets of electronic documents from the total number of occurrences of the word or word string in all the electronic documents and the sum of the numbers of words in all the electronic documents. ((sum of numbers of words)/total number of occurrences of word)

For example, suppose that the frequency of occurrence of the word “spring” in all electronic documents created by user Y (frequency of occurrence in user documents) obtained by the statistical data obtaining unit 202 is 0.8 and the frequency of occurrence of the word in all electronic documents created by the supervisor of user Y is 1.0. Also, suppose that the frequency of occurrence of the word “summer” in all the electronic documents created by user Y obtained by the statistical data obtaining unit 202 is 0.6 and the frequency of occurrence of the word in all the electronic documents created by the supervisor of user Y is 0.8. Because both words “spring” and “summer” are less frequently appear in the electronic documents created by user Y than in the electronic documents created by the supervisor of user Y, the selecting unit 203 infers these words to be less understood by the user. The words “spring” and “summer” are selected as words or words strings about which the user will want to obtain additional information.

Presentation of words or word strings selected as described above can remind staff members that they should be familiar with words or word strings frequently used by their supervisor.

As has been described, the information selecting system in the second example obtains the frequencies of occurrence in user documents and related documents as statistical data and infers words or words strings that appear less frequently in the user documents than in the related documents to be less understood by the user. Thus, the information selecting system in the second example is capable of readily inferring and selecting words or word strings less understood by the user to present to the user.

Generally, words or word strings familiar to people related to a user such as members of a group to which the user belongs are often important word or word strings. The information selecting system in the second example is capable of selecting important words or word strings as well as words or word strings less understood by the user.

While the frequencies of occurrence in related documents created by a member of a group to which the user belongs are obtained in the second example, related documents are not limited to documents created by such a person. For example, the statistical data obtaining unit 202 may obtain the frequencies of occurrence of words or word strings in electronic documents created by a related person in the user's area of specialization as the frequencies of occurrence in related documents. The statistical data obtaining unit 202 may also obtain the frequencies of occurrence of words or word strings in electronic documents created by some other people as the frequencies of occurrence in related documents.

Frequency information relating to a person related to the user obtained by the statistical data obtaining unit 202 is not limited to the frequencies of occurrence in related documents shown in the second example. For example, words or word strings that appear in electronic documents that have been updated or accessed by the user less frequently than a person related to the user may be inferred to be less understood by the user.

For example, the statistical data obtaining unit 202 may perform character or character string matching with all electronic documents in the document database to identify electronic documents in which words or word strings extracted by the word string extracting unit 201 appear. Then the statistical data obtaining unit 202 may obtain the number of updates or accesses made to the identified electronic documents by the user. The statistical data obtaining unit 202 may also obtain the number of updates or accesses made to the electronic documents by a person related to the user.

Then the selecting unit 203 may determine whether the number of updates or accesses made by the user is less than the number of updates or accesses made by the person related to the user. If the number of updates or accesses by the user is less than the number of updates or accesses by the person related to the user, the selecting unit 203 infers that words or words string in the electronic documents are less understood by the user.

### THIRD EXAMPLE

A third example of the present invention will be described with reference to drawings. The third example is a more specific example of the first exemplary embodiment. While the frequencies of occurrence of words or word strings in electronic documents are obtained as statistical data in the first and second examples, the dates and times on which a user updated electronic documents (user document update dates and times) are identified in the third example.

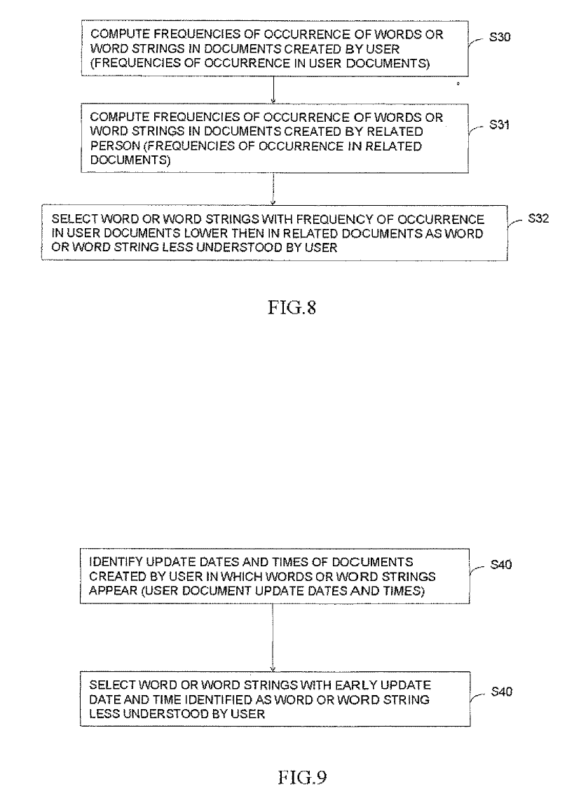

FIG. 9 is a flowchart showing an exemplary process for selecting a word or word string by identifying user document update dates and times. In general, words or word strings that appear in electronic documents last updated by a user earlier are likely to be less understood by the user. The process in the example shown in FIG. 9 selects words or word strings on the basis of this assumption.

Operation at step S40 in FIG. 9 corresponds to step S103 shown in the first exemplary embodiment and operation at step S41 corresponds to step S104 shown in the first exemplary embodiment.

First, statistical data obtaining unit 202 retrieves electronic documents that contain words or word strings extracted by word string extracting unit 201 and are created by user Y from a document database 302. The statistical data obtaining unit 202 then identifies the dates and times the retrieved electronic documents were last updated (user document update dales and times) (S40). Selecting unit 203 selects a words or word string in an electronic document with early user document update date and time identified by the statistical data obtaining unit 202 as words or word strings that is likely to be less understood by the user (S41).

The method shown in the third example selects a word or word string that appear in the electronic document with the earliest update date and time as a word or word string about which the user will want to obtain additional information. The reason is that the user is likely to have forgotten words or word strings used or read earliest. The statistical data obtaining unit 202 performs character string matching between the words or word strings extracted by the word string extracting unit 201 for all electronic documents. The selecting unit 203 compares the electronic documents containing the words or word strings extracted by the word string extracting unit 201 with one another in the order of date to infer the user's levels of understanding of words or word strings.

For example, suppose that the latest date among the update dates of electronic documents in which the word “spring” appears is “04/28/2006” and the latest date among the update dates of electronic documents in which the word “summer” appears is “08/15/2003”. In this case, the word “summer” has the earlier update date and therefore the selecting unit 203 infers the word “summer” to be less understood by the user and selects the word “summer”.

The statistical data obtaining unit 202 may obtain the difference between the identified update date and time of each electronic document and the current date and time. Then the selecting unit 203 may compare each of the time differences obtained by the statistical data obtaining unit 202 with a predetermined threshold (for example 2 years) and a word or word string in all electronic documents the update date and time of which differs from the current date and time by an amount greater than the threshold may be inferred to be less understood by the user.

While the statistical data obtaining unit 202 identifies the update dates and times of electronic documents in the example, the time information to be identified is not limited to update dates and times. For example, the dates and times of creation or access (for example reference) of electronic documents may be identified.

In this way, the information selecting system in the third example identifies the update dates and times of electronic documents as statistical data and infers a word or word string in the electronic document with the earliest update date and time to be less understood by the user. Thus, a word or word string that is likely to be less understood by the user can be readily inferred and selected to present to the user.

Statistical data obtained by the statistical data obtaining unit 202 is not limited to the frequencies of occurrence in user documents, the frequencies of occurrence in related documents, and user document update dates and times given in the examples described above. For example, the statistical data obtaining unit 202 may identify the dates and times on which a person related to the user updated electronic documents (related document update dates and times) in addition to user document update dates and times as statistical data. In this case, the selecting unit 203 may determine whether a user document update date and time is earlier than a related document update date and time, for example. If the user document update date and time is earlier than the related document update date and time, the selecting unit 203 may infer a word or word string in the user document to be less understood by the user.

The person related to the user may be a member of a group to which the user belongs or a person in the same area of specialization as the user. The statistical data obtaining unit 202 may identify the date and time on which an electronic document was updated by some other person, for example as a related document update date and time.

The information selecting system may use a combination of any of the methods of inferring the user's levels of understanding described in the examples to infer the user's levels of understanding of words or word strings extracted from input data. For example, the information selecting system may use a combination of two or three methods of (1) the method of inferring based only on the frequencies of occurrence in user documents, (2) the method of inferring by comparing the frequencies of occurrence in user documents with the frequencies of occurrence in related documents, (3) the method of inferring by using only user document update dates and times, and (4) the method of inferring by comparing user document update dates and times with related document update dates and times. The information selecting system may use the combination of all of the four methods to infer the user's levels of understanding.

### FOURTH EXAMPLE

A fourth example of the present invention will be described with reference to drawings. The fourth example is a more specific example of the first exemplary embodiment. The fourth example described below uses the combination of (2) the method of inferring by comparing the frequencies of occurrence in user documents with the frequencies of occurrence in related documents and (4) the method of inferring by comparing user document update dates and times with related document update dates and times among methods to infer the user's levels of understanding described in the example to infer the user's levels of understanding.

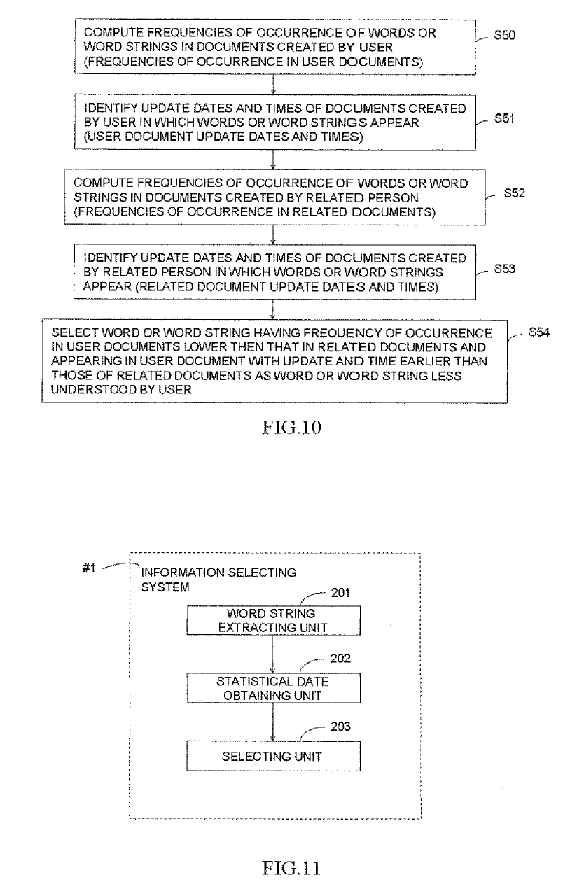

FIG. 10 is a flowchart showing an exemplary process for selecting a word or word string by obtaining the frequencies of occurrence in user documents, the frequencies of occurrence in related documents, user document update dates and times, and related document update dates and times. Operations at step S50 through S53 in FIG. 10 correspond to step S103 shown in the first exemplary embodiment and operation at step S54 corresponds to step S104 shown in the first exemplary embodiment.

First, statistical data obtaining unit 202 retrieves electronic documents created by user Y from a document database 302 and obtains the frequencies of occurrence of words or word strings in the retrieved electronic documents (frequencies of occurrence in user documents) as statistical data (S50). The statistical data obtaining unit 202 identifies the update dates and times of the retrieved electronic documents (user document update dates and times) (S51). The statistical data obtaining unit 202 also retrieves electronic documents created by a member of a group to which user Y belongs (for example the supervisor) from the document database 302 and obtains the frequencies of occurrence of words or word strings in the retrieved electronic documents (frequencies of occurrence in related documents) as statistical data (S52). The statistical data obtaining unit 202 also identifies the update dates and times of the retrieved electronic documents (related document update dates and times) (S53).

Selecting unit 203 selects a word or word string whose frequency of occurrence in the user documents obtained by the statistical data obtaining unit 202 that is lower than that in the related documents and that appears in a user document whose update date and time is earlier than the update dates and time of the related documents as a word or word string less understood by the user (S54).

The selecting unit 203 may infer a word or word string to be less understood by the user at step S54 that satisfies the condition that the frequency of occurrence in the user document obtained by the statistical data obtaining unit 202 is lower than the frequency of occurrence in the related document or the condition that the user document update date and time identified by the statistical data obtaining unit 202 is earlier than the related document update date and time.

As has been described, according to the fourth example, the frequencies of occurrence in user documents, the frequencies of occurrence in related documents, user document update dates and times and related document update dates and times are obtained as statistical data. A word or word string that appears less frequently in the user documents than in the related documents and appears in the user documents the update date and time of which is earlier than the related document update date and time is inferred to be less understood by the user. Thus, a word or word string less understood by the user can be more reliably identified and selected to present to the user. Furthermore, important word or word strings can be more reliably selected in addition to word or word strings less understood by the user.

### FIFTH EXAMPLE

A fifth example of the present invention will be described next. The fifth example is a more specific example of the second exemplary embodiment of the present invention. The information selecting system in the fifth example includes range inferring unit 204. The range inferring unit 204 infers a range in input data from which words or words strings are to be extracted and word string extracting unit 201A extracts words or word strings from the range in the input data inferred by the range inferring unit 204. The range inferring unit 204 may use any of the following method to infer a range, for example.

If input data is streaming data that is presented and flows away such as music data, captions, scrolling tickers, the range inferring unit 204 infers a range in the input data that ends at a point specified by an operation by a user.

The range inferring unit 204 may obtain a range in input data that ends at the timing of occurrence of an event such as a break of speech or a speaker change regardless of whether a user instruction operation is performed or not. For example, when a speaker change occurs in the input data, the range inferring unit 204 infers a segment of the input data in which the former speaker was speaking as the range from which words or a word strings are to be extracted.

If input data is non-streaming data such as non-streaming text, the range inferring unit 204 infers a range the user has traced or circled to be the range from which words or word strings are to be extracted. Alternatively, the range inferring unit 204 may infer a range in input data that begins or ends at a point specified by a user instruction operation to be the range from which word or word strings are to be extracted.

The range inferring unit 204 may infer a range in input data that begins or ends at timing of occurrence of an event such as a page-down or page-up event caused by a user instruction operation. For example, when a page-down operation is performed by the user, the range inferring unit 204 infers the next page in the document displayed to be the range from which words or word strings are to be extracted.

If input data is streaming data, a spoken word such as “Huh?” or “What?” may be recognized as a user instruction operation by using speech recognition. Alternatively, bodily movement such as leaning the head to one side may be recognized as a user instruction operation from a moving picture of the user.

If input data is non-streaming data such as non-streaming text, a user operation with a touch pen or a finger, in addition to a keyboard or mouse operation, may be recognized as a user instruction operation.

In particular, the range inferring unit 204 may obtain a range in input data from which words or word strings are to be extracted in accordance with the following rules. For example, if input data is streaming data, the range inferring unit 204 may obtain a range of the input data for a predetermined period of time such as a period of 3 seconds, a predetermined number of spoken words such as 3 words, a predetermined duration of speech by one speaker, a predetermined number of characters such as 40 characters, or a predetermined number of paragraphs such as two paragraphs.

If input data is non-streaming data such as non-streaming text the range inferring unit 204 may obtain a predetermined number of characters such as 40 characters or a predetermined number of paragraphs such as 2 paragraphs.

Regardless of which of the rules are used to obtain a range, the rules can be flexibly changed by the user.

The operations described above will be described with respect to specific examples. An example in which input data is streaming data will be described first. An example will be first described in which speaker Z is delivering a lecture on investment in stock market and listener Y is listening to the lecture. It is assumed here that the range inferring unit 204 is configured so as to obtain a range of input data for the three preceding seconds as the range from which words or word strings are to be extracted in response to a user instruction.

When speaker Z says, “briks er kapchering thi atensh'n ov investerz theez dayz (BRICs are capturing the attention of investors in these days)”, the speech data is input in the information selecting system and the information selecting system performs speech recognition. Then, the information selecting system obtains the result of the speech recognition, “BRICs are capturing the attention of investors in these days”.

Because the word “BRICs” is unfamiliar to listener Y, listener Y presses a given key on the keyboard, for example. Then the range inferring unit 204 goes back three seconds through the data resulting from the speech recognition from the point at which the key was pressed to obtain the data “BRICs are capturing the attention of investors in these days” as a range from which words or word strings are to be extracted.

The word string extracting unit 201A extracts words “BRICs”, “capturing”, “attention”, and “investors” from the range inferred by the range inferring unit 204 in a manner similar to that in the first example and sends the extracted words or word strings to statistical data obtaining unit 202.

The statistical data obtaining unit 202 and selecting unit 203 given in the following description are the same as those in the first example.

Another example will be described in which input data is non-streaming data. It is assumed here that speaker Z is delivering a lecture on investment in stock market and listener Y is listening to the lecture while displaying a material on the display device of his or her personal computer. It is also assumed that the range inferring unit 204 is configured so as to obtain the next page as the range from which words or word strings are to be extracted in response to a page-down instruction operation by the user.

After speaker Z has finished the first page of the material, listener Y operates his or her personal computer to issue a page-down instruction. It is assumed here that “Investors today are watching ‘BRICs’ with great interest!” is written on the next page. The range inferring unit 204 infers the sentence “Investors today are watching ‘BRICs’ with great interest!” in the text in the input data to be the range from which words or word strings are to be extracted.

The word string extracting unit 201A extracts “investors”, “today”, “BRICs”, and “great interest” from the page obtained by the range inferring unit 204 as a range in a manner similar to that in the first example and sends the extracted words or word strings to the statistical data obtaining unit 202.

The rest of the operations performed by the statistical data obtaining unit 202 and selecting unit 203 are the same as those in the first example.

As has been described above, when data is input in the information selecting system according to the example, the information selecting system infers a range in input data from which words or word strings are to be extracted and infers the user's levels of understanding of the words or word strings extracted from the inferred range. Consequently, the load of the process for inferring the users levels of understanding can be reduced as compared with the process in which words or word strings are extracted one by one and the user's levels of understanding of the words or word strings are inferred in sequence.

A minimum configuration of the information selecting system according to the present invention will be described next. FIG. 11 is a block diagram showing an example of a minimum configuration of the information selecting system. As shown in FIG. 11, the minimum configuration of the information selecting system includes word string extracting unit 201, statistical data obtaining unit 202, and selecting unit 203.

The word string extracting unit 201 includes the function of extracting words or word strings from input data. The statistical data obtaining unit 202 includes the function of obtaining statistical data concerning words or words strings extracted by the word string extracting unit 201 from a group of electronic documents related to a user. The selecting unit 203 selects a word or word string inferred to be less understood by the user on the basis of the statistical data obtained by the statistical data obtaining unit 202 as a word or word string about which the user is likely to want to obtain additional information.

In the information selecting system having the minimum configuration shown in FIG. 11, the statistical data obtaining unit 202 obtains statistical data concerning words or word strings extracted by word string extracting unit 201. The selecting unit 203 selects a word or word string inferred to be less understood by the user on the basis of the statistical data obtained by the statistical data obtaining unit 202. Thus, the information selecting system is capable of inferring and presenting a word or words string about which the user will want to obtain additional information as in the exemplary embodiments and examples described above. Therefore, the need for the user to select by themselves a word or word string about which the user wants to obtain information from among words or word strings presented by a system can be eliminated.

The following features (1) to (10) are shown in the exemplary embodiments and examples described above.
(1) The information selecting system includes: word string extracting unit (implemented by the word string extracting unit 201, for example) extracts word or word strings from input data; statistical data obtaining unit (implemented by the statistical data obtaining unit 202, for example) obtains statistical data concerning words or word strings extracted by the word string extracting unit from a group of electronic documents relating to the input data; and selecting unit (implemented by the selecting unit 203, for example) selects a word or word string inferred to be less understood by a user on the basis of statistical data obtained by the statistical data obtaining unit. With this configuration, a word or word string about which the user wants to obtain additional information can be inferred and presented to the user. This can eliminate the need for the user to select the word or word string about which the user wants to obtain additional information from among words or word strings presented by a system.
(2) The statistical data obtaining unit may obtain the frequencies of occurrence of words or word strings in an electronic document as statistical data; and the selecting unit may infer that a word or word string that appears less frequently is less understood by a user on the basis of the frequencies of occurrence obtained by the statistical data obtaining unit. With this configuration, a word or word string less understood by the user can be readily inferred, selected and presented to the user on the basis of the frequencies of occurrence.
(3) The statistical data obtaining unit may identify predetermined date-and-time information for electronic documents in which each word or word string appears (for example the creation dates and times or update dates and times of electronic documents) as statistical data; and the selecting unit may infer that a word or word string with an earlier date and time indicated in the date-and-time information identified by the statistical data obtaining unit is less understood by the user. With this configuration, a word or word string less understood by the user can be readily inferred, selected and presented to the user on the basis of given date-and-time information for electronic documents.
(4) The statistical data obtaining unit may obtain the frequencies of occurrence of words or word strings in a user document created by the user as statistical data; and the selecting unit may infer that a word or word string with a low frequency of occurrence in the user document obtained by the statistical data obtaining unit is less understood by the user. With this configuration, a word or word string less understood by the user can be readily inferred, selected and presented to the user on the basis of the frequencies of occurrence in user documents.
(5) The statistical data obtaining unit may obtain the frequencies of occurrence of words or word strings in the user electronic document created by the user and the frequencies of occurrence of words or word strings in a related electronic document created by a person related to the user; and the selecting unit may infer that a word or word string the frequency of occurrence of which in the user document obtained by the statistical data obtaining unit is lower than the frequency in the related document is less understood by the user. With this configuration, a word or word string less understood by the user can be readily inferred, selected and presented to the user on the basis of the frequencies of occurrence in user documents and related documents. In addition to the word or word string less understood by the user, an important word or word string can be selected.
(6) The information selecting system may further include range inferring unit (implemented by the range inferring unit 204, for example) infers a range in input data in which words or word strings are to be extracted, wherein the word string extracting unit may extract words or word strings in the range in the input data inferred by the range inferring unit. This configuration can reduce the load of the process for inferring the user's levels of understanding as compared with a configuration in which words or word strings are extracted one by one and the user's levels of understanding of the words or word strings are inferred in sequence.
(7) The word string extracting unit may extract words or word strings in input data in a predetermined period of time, a predetermined number of characters, or a segment between punctuation marks.
(8) The word string extracting unit may extract a word, word compound, segment, phrase, sentence, paragraph, section, clause, or chapter as a unit of word or word string extraction.
(9) The information selecting system may include a document database storing at least one of an electronic document created by the user, an electronic document created by a member of a team to which the user belongs, and an electronic document created in the user's area of specialization as an electronic document related to the user.
(10) The document database may store a list of the frequencies of occurrence of words or word strings in each electronic document related to the user.

The present invention is applicable to applications such as search systems for searching the Web or dictionary for words or word strings. The present invention is also applicable to conference support systems for video or Web conferences. The present invention is also applicable to reading support systems which facilitates reading various kinds of text or searches for translations of words to provide translated text. The information selecting system according to the present invention is also applicable to a learning support system which searches for various kinds of learning information such as language learning information.

The present invention has been described in detail. However, it should be appreciated that various changes may be made to the present invention without departing from its spirits and be covered by the claims.

Furthermore, it is the inventor's intent to retain all equivalents of the claimed invention even if the claims are amended during prosecution.

What is claimed is:

1. An information selecting system comprising:
word string extracting unit that extracts word or word strings from input data;
statistical data obtaining unit that obtains statistical data concerning words or word strings extracted by said word string extracting unit from a group of electronic documents relating to said input data; and
selecting unit that selects a word or word string on the basis of said statistical data obtained by said statistical data obtaining unit.

2. The information selecting system according to claim 1, wherein:
said statistical data obtaining unit obtains the frequencies of occurrence of words or word strings in an electronic document; and
said selecting unit infers that a word or word string that appears less frequently is less understood by a user on the basis of the frequencies of occurrence obtained by said statistical data obtaining unit.

3. The information selecting system according to claim 1, wherein:
said statistical data obtaining unit identifies predetermined date-and-time information for electronic documents in which each word or word string appears as statistical data; and
said selecting unit infers that a word or word string with an earlier date and time indicated in the date-and-time information identified by said statistical data obtaining unit is less understood by the user.

4. The information selecting system according to claim 2, wherein:
said statistical data obtaining unit obtains the frequencies of occurrence of words or word strings in a document created by the user as statistical data; and
said selecting unit infers that a word or word string with a low frequency of occurrence in said document obtained by said statistical data obtaining unit is less understood by the user.

5. The information selecting system according to claim 2, wherein:
said statistical data obtaining unit obtains the frequencies of occurrence of words or word strings in the user electronic document created by the user and the frequencies of occurrence of words or word strings in a related electronic document created by a person related to the user; and
said selecting unit infers that a word or word string the frequency of occurrence of which in said document obtained by said statistical data obtaining unit is lower than the frequency in the related document is less understood by the user.

6. The information selecting system according to claim 1, further comprising range inferring unit for inferring a range in input data in which words or word strings are to be extracted,
wherein said word string extracting unit extracts words or word strings in the range in said input data inferred by said range inferring unit.

7. The information selecting system according to claim 1, wherein said word string extracting unit extracts words or word strings in input data in a predetermined period of time, a predetermined number of characters, or a segment between punctuation marks.

8. The information selecting system according to claim 1, wherein said word string extracting unit extracts a word, word compound, segment, phrase, sentence, paragraph, section, clause, or chapter as a unit of word or word string extraction.

9. The information selecting system according to claim 1, further comprising a document database storing at least one of an electronic document created by the user, an electronic document created by a member of a team to which the user belongs, and an electronic document created in the user's area of specialization as an electronic document related to the user.

10. The information selecting system according to claim 9, wherein the document database stores a list of the frequencies of occurrence of words or word strings in each electronic document related to the user.

11. An information selecting method comprising the steps of:
extracting word or word strings from input data;
obtaining statistical data concerning the words or word strings extracted from a group of electronic documents related to a user; and
selecting a word or word string on the basis of statistical data obtained.

12. The information selecting method according to claim 11, wherein:
in said statistical data obtaining step, the frequencies of occurrence of words or word strings in an electronic document is obtained as statistical data; and
in said selecting step, it is inferred that a word or word string that appears less frequently is less understood by a user on the basis of the frequencies of occurrence obtained in said statistical data obtaining step.

13. The information selecting method according to claim 11, wherein:
in said statistical data obtaining step, predetermined date-and-time information for electronic documents in which each word or word string appears is identified as statistical data; and
in said selecting step, it is inferred that a word or word string with an earlier date and time indicated in the date-and-time information identified is less understood by the user.

14. The information selecting method according to claim 12, wherein:
in said statistical data obtaining step, the frequencies of occurrence of words or word strings in a document created by the user are obtained as statistical data; and
in said selecting step, it is inferred that a word or word string with a low frequency of occurrence in said document obtained is less understood by the user.

15. The information selecting method according to claim 12, wherein:
in the statistical data obtaining step, the frequencies of occurrence of words or word strings in the user electronic document created by the user and the frequencies of occurrence of words or word strings in a related electronic document created by a person related to the user are obtained; and
in the selecting step, it is inferred that a word or word string the frequency of occurrence of which in the user document obtained in the statistical data obtaining step is lower than the frequency in the related document is less understood by the user.

16. The information selecting method according to claim 11, further comprising the step of inferring a range in input data in which words or word strings are to be extracted,
wherein, in the word string extracting step, words or word strings in the inferred range in the input data inferred are extracted.

17. The information selecting method according to claim 11, wherein, in the word string extracting step, words or word strings in a predetermined period of time, a predetermined number of characters, or a segment between punctuation marks in input data are extracted.

18. The information selecting method according to claim 11, wherein, in the word string extracting step, a word, word compound, segment, phrase, sentence, paragraph, section, clause, or chapter is extracted as a unit of word or word string extraction.

19. The information selecting method according to claim 11, wherein at least one of an electronic document created by the user, an electronic document created by a member of a team to which the user belongs, and an electronic document created in the user's area of specialization is stored in a document database as an electronic document related to the user.

20. The information selecting method according to claim 19, wherein a list of the frequencies of occurrence of words or word strings in each electronic document related to the user is stored in the document database.

21. An information selecting program causing a computer to perform the steps of:
extracting word or word strings from input data;
obtaining statistical data concerning words or word strings extracted in the word string extracting step from a group of electronic documents related to a user; and
selecting a word or word string on the basis of statistical data obtained in the statistical data obtaining step.

22. The information selecting program according to claim 21, wherein the computer is caused to:
in the statistical data obtaining step, obtain the frequencies of occurrence of words or word strings in an electronic document as statistical data; and
in the selecting steps infer that a word or word string that appears less frequently is less understood by a user on the basis of the frequencies of occurrence obtained in the statistical data obtaining step.

23. The information selecting program according to claim 21, wherein the computer is caused to:
in the statistical data obtaining step, identify predetermined date-and-time information for electronic documents in which each word or word string appears as statistical data; and
in the selecting step, infer that a word or word string with an earlier date and time indicated in the date-and-time information identified in the statistical data obtaining step is less understood by the user.

24. The information selecting program according to claim 22, wherein the computer is caused to:
in the statistical data obtaining step, obtain the frequencies of occurrence of words or word strings in a user document created by the user as statistical data; and
in the selecting step, infer that a word or word string with a low frequency of occurrence in the user document obtained in the statistical data obtaining step is less understood by the user.

25. The information selecting program according to claim 22, wherein the computer is caused to:
in the statistical data obtaining step, obtain the frequencies of occurrence of words or word strings in the user electronic document created by the user and the frequencies of occurrence of words or word strings in a related electronic document created by a person related to the user; and
in the selecting step, infer that a word or word string the frequency of occurrence of which in the user document obtained in the statistical data obtaining step is lower than the frequency in the related document is less understood by the user.

26. The information selecting program according to claim 21, wherein the computer is caused to perform the step of inferring a range in input data in which words or word strings are to be extracted; and
in the word string extracting step, to extract words or word strings in the range in the input data inferred in the range inferring step.

27. The information selecting program according to claim 21, wherein the computer is caused to:
in the word string extracting step, extract words or word strings in a predetermined period of time, a predetermined number of characters, or a segment between punctuation marks in input data.

28. The information selecting program according to claim 21, wherein the computer is caused to, in the word string extracting step, extract a word, word compound, segment, phrase, sentence, paragraph, section, clause, or chapter as a unit of word or word string extraction.
